(19) United States
(12) Patent Application Publication
(10) Pub. No.: US 2019/0164323 A1
(43) Pub. Date: May 30, 2019

(54) METHOD AND PROGRAM FOR GENERATING VIRTUAL REALITY CONTENTS

(71) Applicant: Moo A Kim, Seoul (KR)

(72) Inventor: Moo A Kim, Seoul (KR)

(21) Appl. No.: 16/119,086

(22) Filed: Aug. 31, 2018

(30) Foreign Application Priority Data
Nov. 28, 2017 (KR) 10-2017-0160507

(51) Int. Cl. G06T 11/60; G06T 3/00

(52) U.S. Cl. CPC G06T 11/60; G06T 2200/24; G06T 3/0018

(57) ABSTRACT

A method of generating virtual reality (VR) contents by a computer includes: determining a background of the virtual reality contents; determining one or more objects to be included in the virtual reality contents, the one or more objects including a predetermined scenario which is interactable with the user in response to an input of a user who uses the virtual reality contents; and generating the virtual reality contents including the determined background and one or more objects.

### REFERENCE TO RELATED APPLICATIONS

This application claims the priority benefit of Korean Patent Application No. 1.0-201.7-01.60507 filed on Nov. 28, 2017, the entire contents of which are incorporated herein by reference.

### FIELD OF THE INVENTION

The present disclosure relates to a method and a program for generating virtual reality contents.

### BACKGROUND OF THE INVENTION

Virtual reality (VR) is a human-computer interface which creates a specific environment or situation by a computer to allow a user to feel as if the user interacts with an actual surrounding environment.

Augmented reality (AR) is a technology which superimposes a virtual object on a user's view of the real world. Augmented Reality is also referred to as Mixed Reality (MR) because it combines the real world with the virtual world having additional information in real time to show a single image.

Recently, although various virtual reality image development tools have been provided in accordance with the spread of virtual reality equipment, it is not easy for an amateur who is not a developer to create a desired virtual reality image.

Therefore, development of a technique and a service which allow even an amateur to generate the virtual reality contents through a simple interface is demanded.

### SUMMARY OF THE INVENTION

An object to be achieved by the present disclosure is to provide a method and a program for generating virtual reality contents.

Technical problems of the present invention are not limited to the above-mentioned technical problems, and other technical problems, which are not mentioned above, can be clearly understood by those skilled in the art from the following descriptions.

According to an aspect of the present disclosure, a method of generating virtual reality (VR) contents by a computer includes determining a background of the virtual reality contents, determining one or more objects to be included in the virtual reality contents, the one or more objects including a predetermined scenario which is interactable with the user in response to an input of a user who uses the virtual reality contents, and generating the virtual reality contents including the determined background and one or more objects.

The determining of a background may include determining a close-range view of the virtual reality contents and determining a distant view of the virtual reality contents.

The determining of a background may include providing a list including one or more backgrounds, receiving a selection input for at least one background included in the list, and determining the selected background as a background of the virtual reality contents.

The determining of a background may include obtaining an image to be used as a background of the virtual reality contents and determining the obtained image as a background of the virtual reality contents.

The determining of a background may further include converting the obtained image into a 360-degree image when the obtained image is not a 360-degree image.

Further, the converting of the obtained image may include obtaining a distortion pattern image corresponding to distortion of an image generated during a process of converting the obtained image into a 360-degree image, distorting the obtained image based on the obtained distortion pattern image, and converting the distorted image into a 360-degree image.

The determining of one or more objects may include providing a list including one or more objects, receiving a selection input for at least one object included in the list, and adding the selected object to the virtual reality contents.

The determining of one or more objects may include determining a shape of the one or more objects and determining a scenario of the one or more objects and the scenario may include at least one of an appearance condition, an appearance position, an appearance time of one or more objects, a user's input recognition method for one or more objects, a reaction to the input of the user, and a result in accordance with the interaction between the user and one or more objects.

The method may further include sharing the generated virtual reality contents and obtaining a feedback for the shared virtual reality contents.

According to another aspect of the present disclosure, a computer program which is combined with a computer which is a hardware to be stored in a computer readable recording medium to perform a method for generating virtual reality contents according to the disclosed embodiment is provided.

Other detailed matters of the embodiments are included in the detailed description and the drawings.

According to the disclosed embodiment, a method which allows the user to select the background and the object to easily generate and share virtual reality contents.

The effects of the present disclosure are not limited to the technical effects mentioned above, and other effects which are not mentioned can be clearly understood by those skilled in the art from the following description.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a conceptual view illustrating a system which generates virtual reality contents according to a disclosed embodiment;

FIG. 2 is a flowchart illustrating a method for generating virtual reality contents according to an exemplary embodiment;

FIG. 3 is a view illustrating an example of a screen which generates virtual reality contents according to the disclosed embodiment;

FIG. 4 is a view illustrating an example of a screen of virtual reality contents generated according to an exemplary embodiment illustrated in FIG. 3;

FIG. 5 is a view illustrating an example of generating virtual reality contents using an obtained image;

FIG. 6 is a view illustrating an example of generating a 360-degree image through distortion of an image; and

FIG. 7 is a view illustrating an example of a distortion pattern image which is obtained by a computer.

### DETAILED DESCRIPTION OF THE INVENTION

Advantages and characteristics of the present invention and a method of achieving the advantages and characteristics will be clear by referring to exemplary embodiments described below in detail together with the accompanying drawings. However, the present invention is not limited to exemplary embodiments disclosed herein but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims.

The terms used in the present specification are for explaining the embodiments rather than limiting the present invention. Unless particularly stated otherwise in the present specification, a singular form also includes a plural form. The term “comprise” and/or “comprising” used in the specification does not exclude the presence or addition of one or more other components in addition to the mentioned component. Like reference numerals generally denote like elements throughout the specification and “and/or” includes each of mentioned components and all combinations of one or more components. Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

The term “˜unit” or “˜module” used in the specification refers to a hardware component such as FPGA or ASIC and the “unit” or “module” performs some functions. However, “˜unit” or “˜module” is not limited to the software or the hardware. “˜unit” or “˜module” may be configured to be in an addressable storage medium or may be configured to reproduce one or more processors. Accordingly, as an example, “˜unit” or “˜module” includes components such as software components, object oriented software components, class components, and task components, processes, functions, attributes, procedures, subroutines, segments of a program code, drivers, a firmware, a microcode, a circuit, data, database, data structures, tables, arrays, and variables. A function which is provided in the components and “˜units” or “˜modules” may be combined with a smaller number of components and “˜units” or “˜modules” or divided into additional components and “˜units” or “˜modules”.

In the specification, the virtual reality and the virtual reality image are not limited to the VR and the VR reality but include all virtual reality (VR), virtual reality images, augmented reality (AR), augmented reality images, mixed reality (MR), and mixed reality images, and normal images. Further, it is not limited thereto and includes any type of images such as real images, virtual images, and a mixed image of a real image and a virtual image.

Further, it is obviously understood by those skilled in the art that exemplary embodiments of the method of utilizing virtual reality equipment disclosed in the specification are applicable to all the virtual reality (VR), the augmented reality (AR), the mixed reality (MR), and normal images.

Hereinafter, exemplary embodiments of the present disclosure will be described in detail with reference to the accompanying drawings.

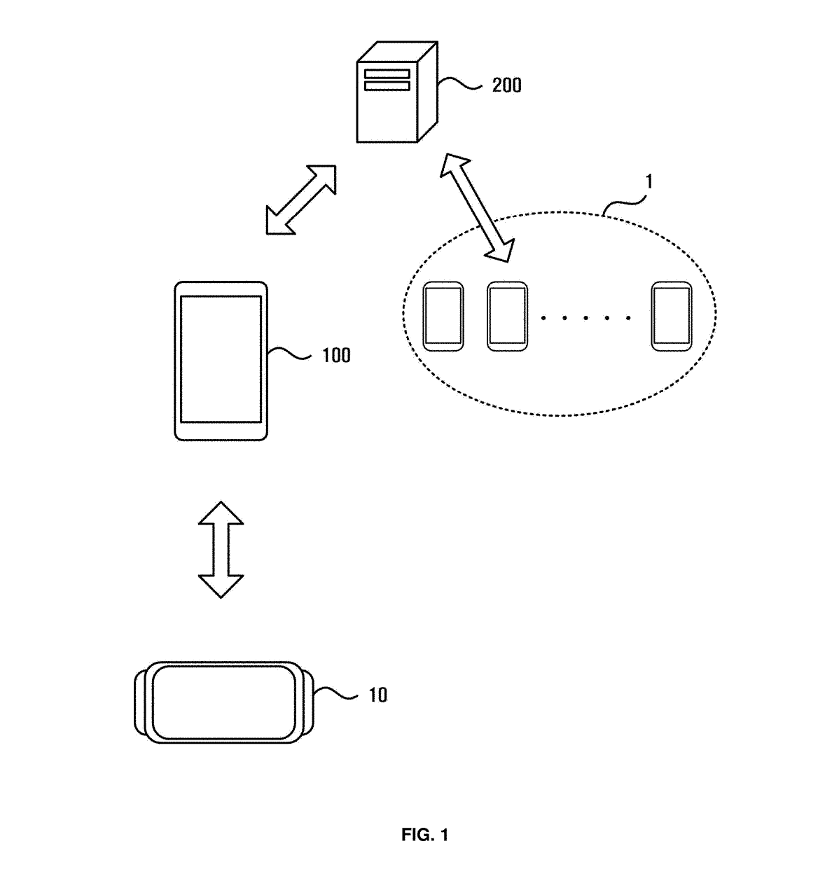

FIG. 1 is a conceptual view illustrating a system which generates virtual reality contents according to a disclosed embodiment;

Referring to FIG. 1, a system which generates virtual reality contents includes a client 100 and a server 200.

In one exemplary embodiment, the system which generates virtual reality contents includes virtual reality equipment 10.

In one exemplary embodiment, the system which generates virtual reality contents further includes a plurality of different user clients 1.

In one exemplary embodiment, the user client 100 and the server 200 refer to a computer or a program which operates in the computer.

In the exemplary embodiment disclosed in this specification, the computer is used to means all kinds of devices including at least one processor. For example, the computer means a desktop computer, a notebook (laptop) computer, a smart phone or a tablet PC.

A part or all of the method for generating virtual reality contents according to the exemplary embodiment disclosed below is performed by the user client 100 or the server 200.

In one exemplary embodiment, the user client 100 transmits information used for the virtual reality contents generating method according to the disclosed embodiment to the server 200 and the server 200 performs the virtual reality contents generating method according to the disclosed embodiment and transmits the result to the user client 100.

In one exemplary embodiment, the user client 100 downloads a program for performing the virtual reality contents generating method according to the disclosed embodiment from the server 200 or other external servers and performs the virtual reality contents generating method according to the disclosed embodiment using the downloaded program.

In one exemplary embodiment, the user client 100 accesses the server 200 through a web page and performs the virtual reality contents generating method according to the disclosed embodiment using a single page application (SPA) provided from the server 200.

The above-described embodiments are provided as examples and a method which performs all or a part of the virtual reality contents generating method according to the disclosed embodiment in the user client 100 or the server 200 hereinbelow is not limited thereto.

In one exemplary embodiment, the user may view the virtual reality contents generated by the user client 100 or the server 200 using the virtual reality equipment 10 and the user client 100.

In another exemplary embodiment, the user may view the virtual reality contents generated by the user client 100 or the server 200 in the form of a 360-degree image using the user client 100.

In one exemplary embodiment, the virtual reality contents generated by the user client 100 or the server 200 are shared through a network and a plurality of different user clients 1 may reproduce the shared virtual reality contents.

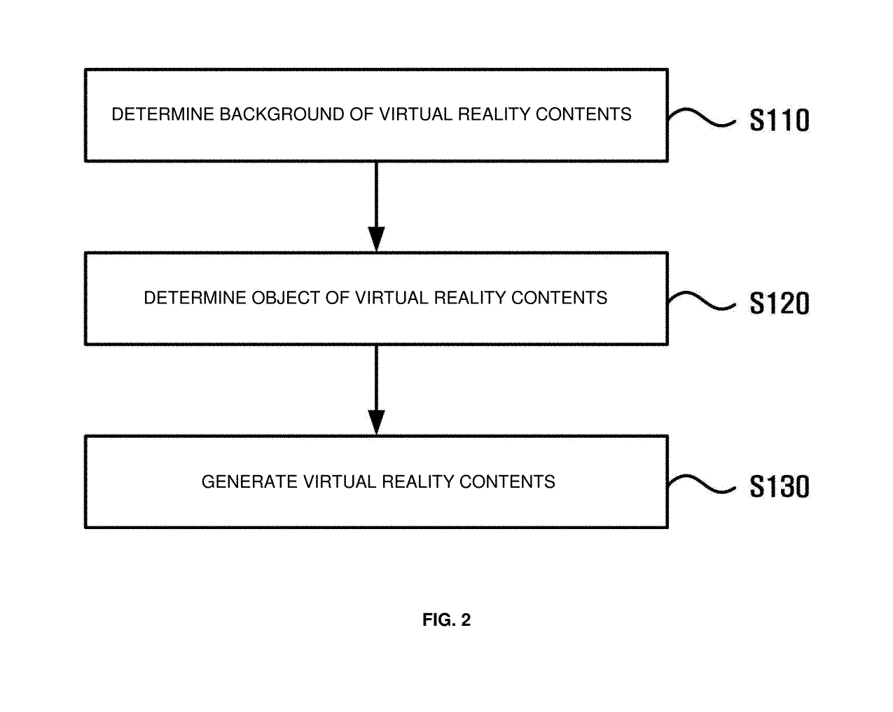

FIG. 2 is a flowchart illustrating a method for generating virtual reality contents according to an exemplary embodiment.

Steps illustrated in FIG. 2 are performed in the user client 100 or the server 200 illustrated in FIG. 1 in a time series manner. Hereinafter, for the convenience of description, although it is described that the steps illustrated in FIG. 2 are performed by a “computer”, the “computer” may be any one of the user client 100 and the server 200. Specifically, a subject which performs the steps illustrated in FIG. 2 is not limited and all or a part thereof may be performed in the user client 100 or the server 200.

In step S110, the computer determines a background of virtual reality contents.

In one exemplary embodiment, the background of the virtual reality contents includes a 300-degree image used as a background of the virtual reality contents. The 360-degree image may be a 2D image or a rendered 3D image.

In one exemplary embodiment, the background of the virtual reality contents includes a close-range view and a distant view.

In the disclosed embodiment, the close-range view includes an environment in the virtual reality contents. For example, the close-range view includes information on whether a surrounding environment close to the user's viewpoint in the virtual reality contents is a desert, a forest, a mountain, a sea, or a building and a kind of building if there is a building.

For example, the close-range view may include information on the ground in the virtual reality contents. The close-range view may include information on a surrounding environment which is three-dimensionally rendered.

In the disclosed embodiment, the distant view refers to a background which is far from the user's viewpoint in the virtual reality contents. For example, the distant view may include information on the sky in the virtual reality contents.

In one exemplary embodiment, a computer provides a list including at least one background which can be used as a background of the virtual reality contents and receives a selection input for at least one background included in the provided list. The computer determines the selected background as the background of the virtual reality contents.

In one exemplary embodiment, a computer provides a list including at least one background which can be used as a close-range view of the virtual reality contents and receives a selection input for at least one background included in the provided list. The computer determines the selected background as the close-range view of the virtual reality contents.

In one exemplary embodiment, a computer provides a list including at least one background which can be used as a distant view of the virtual reality contents and receives a selection input for at least one background included in the provided list. The computer determines the selected background as the distant view of the virtual reality contents.

In the exemplary embodiment, the close-range view and the distant view may affect each other. For example, the close-range view displayed in the virtual reality contents may vary depending on the kind of the distant view and the distant view may be also displayed to vary depending on the kind of the close-range view.

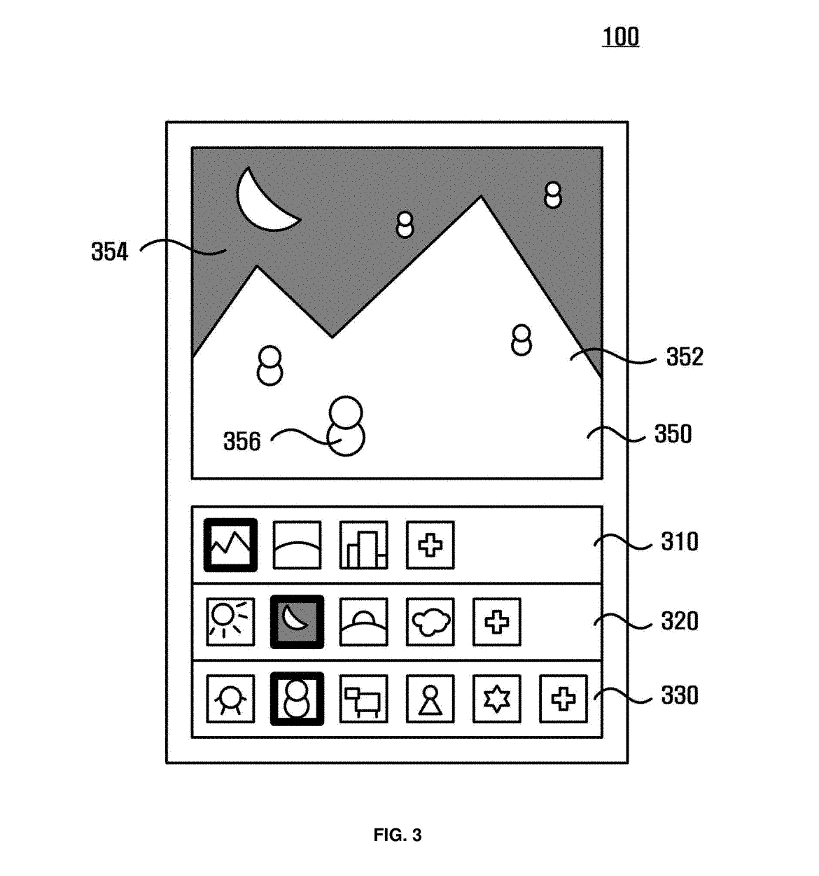

Referring to FIG. 3, an example of a screen which generates virtual reality contents according to the disclosed embodiment is illustrated.

In the exemplary embodiment illustrated in FIG. 3, on the screen which generates the virtual reality contents, a list 310 for selecting a close-range view 352 of the virtual reality contents and a list 320 for selecting a distant view 354 of the virtual reality contents are displayed.

For example, in the list 310, a mountain, a sea, and a building which may be the close-range view of the virtual reality contents are displayed and the close-range view of the virtual reality contents is determined by the selection of the user. Further, in addition to the close-range view which has been already set by the selection of the user, an image which is input by the user may be set as the close-range view of the virtual reality contents.

As another example, the close-range view of the virtual reality contents may be omitted.

For example, in the list 320, a clear sky, a night sky with a moon, a sunset, and a cloud which may be distant view of the virtual reality contents are displayed and the distant view of the virtual reality contents is determined by the selection of the user. Further, in addition to the distant view which has been already set by the selection of the user, an image which is input by the user may be set as the distant view of the virtual reality contents.

Further, an example screen 350 of the virtual reality contents which is generated according to the selection result is displayed.

For example, the close-range view selected from the list 310 is displayed as a close-range view of the example screen 350 and the distant view selected from the list 320 is displayed as a distant view of the example screen 350.

In one exemplary embodiment, the computer obtains an image which may be used as the background of the virtual reality contents. The computer may obtain an image stored in the memory, an image transmitted from an external terminal, or an image photographed using at least one photographic device. In the disclosed embodiment, a method which obtains images by a computer is not limited thereto.

The computer determines the obtained image as the background of the virtual reality contents.

In one exemplary embodiment, the computer determines the obtained image as a distant view of the virtual reality contents.

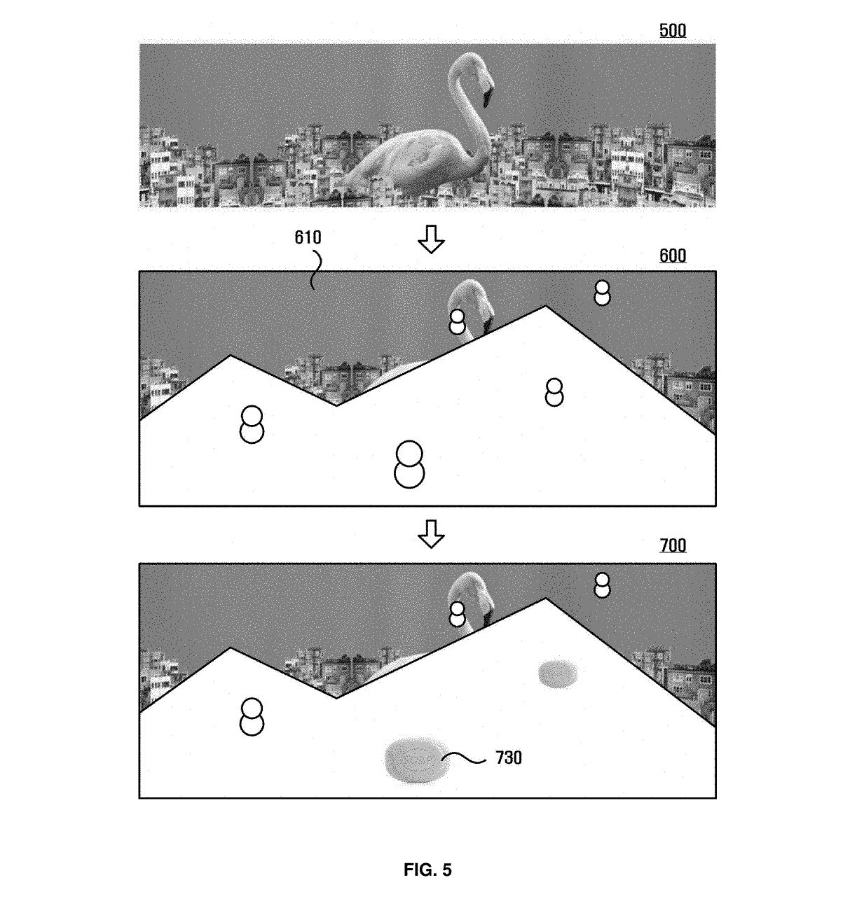

Referring to FIG. 5, an example which generates virtual reality contents using the obtained image is illustrated.

In one exemplary embodiment, the computer obtains an image 500 which serves as the background of the virtual reality contents. The obtained image 500 is displayed as a distant view 610 of the virtual reality contents 600.

Even though the image of the virtual reality contents 600 illustrated in FIG. 5 is a panorama image which is long in a horizontal direction, actually, the virtual reality contents 600 illustrated in FIG. 5 is a 360-degree virtual reality image. It is understood that the image illustrated in FIG. 5 are obtained by spreading the 360-degree virtual reality image.

In one exemplary embodiment, the obtained image 500 may not be a 360-degree image. In this case, the computer converts the image 500 into a 360-degree image.

In one exemplary embodiment, when the image 360 is a panorama image which is rollable as a 360-degree image, a single image 500 may be converted into the 360-degree image.

In another exemplary embodiment, when the image 500 is an image whose horizontal length is short so that it is difficult to roll the image as a 360-degree image, the image is mirrored or copied and a plurality of images is connected so that the connected image may be converted into a 360-degree image. Further, the image 500 is zoomed or cropped to be converted into a 360-degree image.

In one exemplary embodiment, during a process of converting an image into a 360-degree image, the image may be distorted.

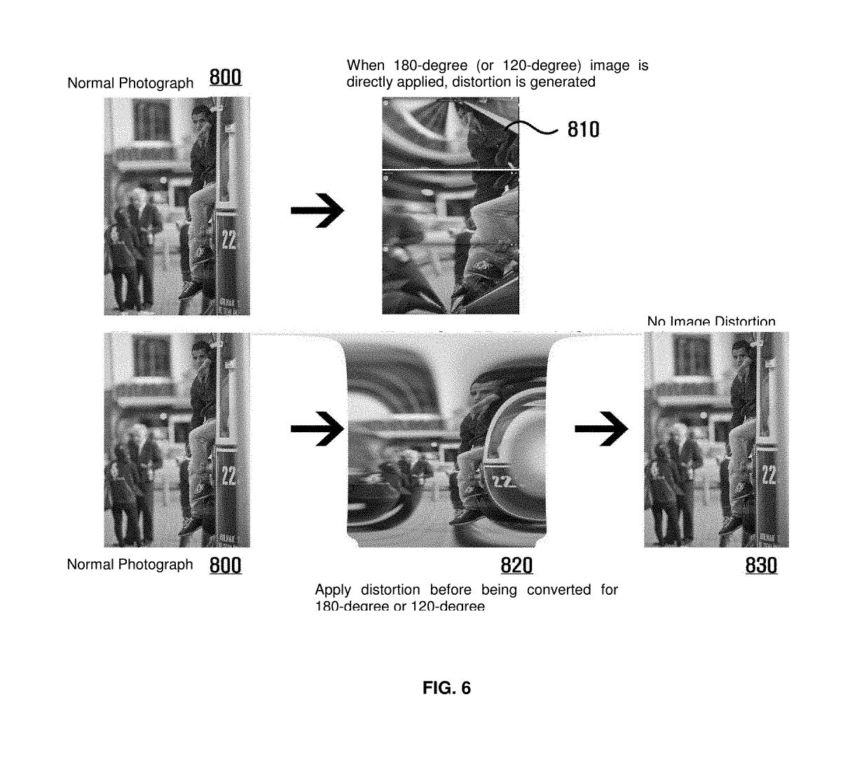

For example, as illustrated in FIG. 6, when a normal photograph 800 is converted into a 360-degree (including 180-degree and 120-degree) image, distortion is generated so that a distorted image 810 is generated.

Therefore, the computer obtains a distortion pattern image corresponding to the distortion of the image which is generated during the process of converting the image 800 into a 360-degree image.

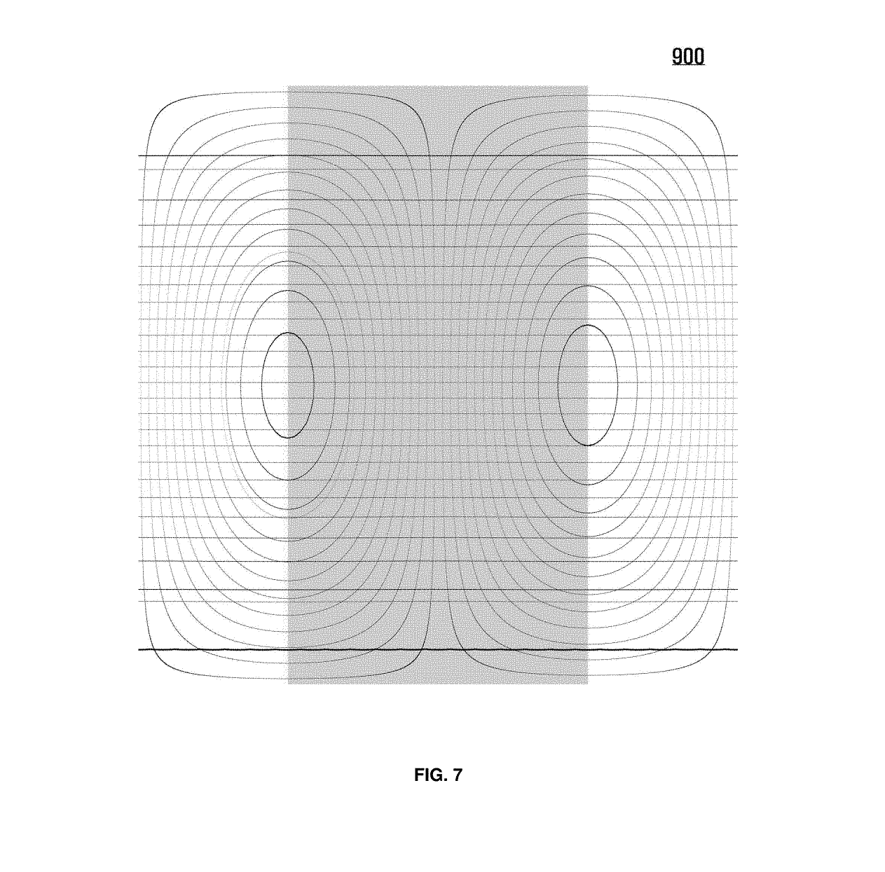

Referring to FIG. 7, an example of a distortion pattern image 900 which may be obtained by the computer is illustrated.

The computer distorts the image 800 based on the obtained distortion pattern image 900. The computer converts the distorted image 820 into a 360-degree image to obtain a result 830 which does not have a distortion.

In step S120, the computer determines one or more objects to be included in the virtual reality contents. One or more objects may include a predetermined scenario which may interact with the user in accordance with an input of a user who uses the virtual reality contents.

In one exemplary embodiment, the computer provides a list including one or more objects and receives the selection input for at least one object included in the list from the user. The computer adds the selected object to the virtual reality contents.

In one exemplary embodiment, the object includes a shape and a scenario.

Therefore, when one or more objects to be added to the virtual reality contents are determined, the computer determines a shape of one or more objects and determines a scenario of one or more objects.

In one exemplary embodiment, the list including one or more objects which is provided by the computer includes objects in which a shape and a scenario are already combined and an object in which the shape and the scenario have been determined may be added to the virtual reality contents in accordance with the selection of the user.

In another exemplary embodiment, the computer separately determines the shape and the scenario of each object to combine the shape and the scenario. For example, the computer provides a list which includes only the scenario of the object and receives selection and also separately receives the selections of a shape of the object corresponding to each scenario and adds an object which is generated by combining the scenario and the shape to the virtual reality contents.

In one exemplary embodiment, the computer obtains an image from the user and determines the obtained image as a shape of the object.

In one exemplary embodiment, the scenario of the object includes at least one of an appearance condition, an appearance position, and an appearance time of the object, a user's input recognition method for one or more object, a reaction to the input of the user, and a result in accordance with interaction between the user and the one or more objects.

However, the type of the scenario of the object is not limited thereto and actions based on more scenarios through interaction with the user may be obtained.

Referring to FIG. 3, an example in which a list 330 including one or more objects and an object 356 selected from the list 330 are displayed on an example screen 350 is illustrated.

The objects displayed in the virtual reality contents are displayed at a specific viewpoint which is set in advance or randomized and moves in accordance with a predetermined or randomized motion.

One or more objects may be displayed in the virtual reality contents and a plurality of one type of objects may be displayed to interact with the user or different types of objects are displayed to interact with the user.

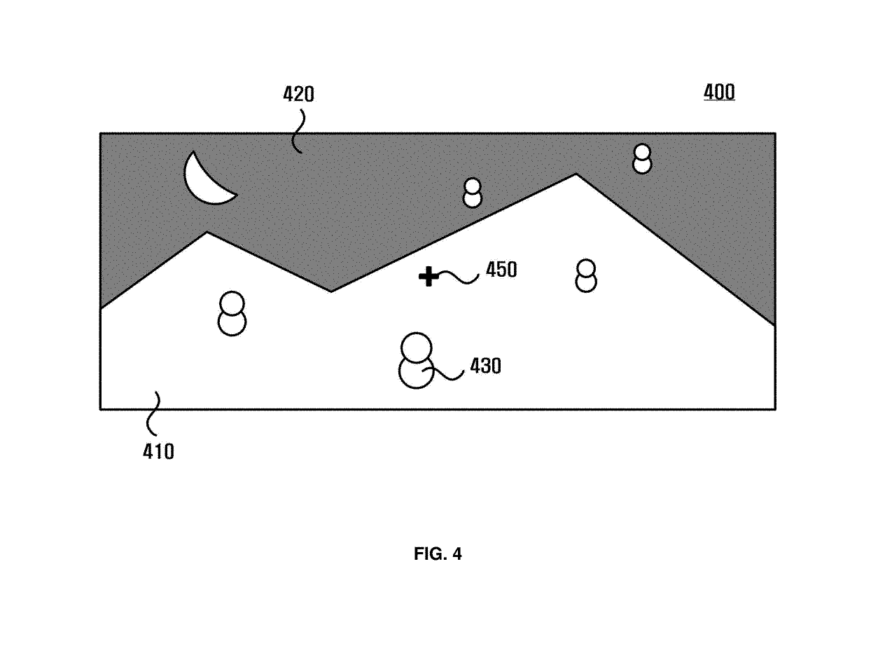

Referring to FIG. 4, an example of a screen of the virtual reality contents generated according to an exemplary embodiment illustrated in FIG. 3 is illustrated. As described above, even though the image of the virtual reality contents 400 illustrated in FIG. 4 is a panorama image which is long in a horizontal direction, actually, the virtual reality contents 400 illustrated in FIG. 4 are a 360-degree virtual reality image and it is understood that the image illustrated in FIG. 4 is obtained by spreading the 360-degree virtual reality image.

In one exemplary embodiment, a marker 450 may be displayed near the center of the virtual reality contents 400. The marker 450 is generally displayed in a viewing direction of the user and the computer receives the input of the user through the marker 450.

For example, when the user indicates a specific object for a predetermined time or longer using the marker 450 or performs additional input through a button or touch while indicating the specific object using the marker 450, the input of the user for an object indicated by the marker 450 is recognized.

The object corresponding to the input of the user interacts in accordance with the input of the user. For example, the object corresponding to the input of the user may be moved to another position, enlarged, downsized, shined, decolored, or disappear, or pay an item or points to the user.

A method that the object interacts in accordance with the input of the user is not limited thereto and various interacting methods may be used.

For example, the computer recognizes a motion of the user, a virtual reality controller which is used by the user, or a part of a body of the user to recognize the selection input of the user which selects an object.

Referring to FIG. 5, virtual reality contents 700 including an object 730 with which an image is combined are illustrated.

In one exemplary embodiment, the computer may combine the image obtained from the user with the object 730. For example, the computer determines a shape of the object 730 by an image obtained from the user and displays the shape in the virtual reality contents.

For example, the virtual reality contents may include an advertisement. For example, the advertisement may be displayed on the background of the virtual reality contents. For example, an advertisement image or video is converted into a 360-degree image or video to be displayed in the distant view of the virtual reality contents.

Further, the advertisement may be displayed by combining the advertisement image or video with a part of the close-range view or the distant view of the virtual reality contents. For example, the advertisement may be displayed in a partial space of the distant view of the virtual reality contents or displayed by being combined with an object (for example, cloud, the sun, or an airship) included in the close-range view or the distant view.

When the user selects the advertisement, information relating the advertisement is displayed in the virtual reality contents or the user may move to a link corresponding to the advertisement.

In one exemplary embodiment, the advertisement may be displayed to be combined with the object. For example, as illustrated in FIG. 5, an image of a product to be advertised is combined with the object 730 to interact with the user in accordance with the scenario included in the object 730.

In one exemplary embodiment, when the advertisement is combined with the object, a scenario previously determined by the advertisement is added to the scenario of the object or replaces the scenario of the object.

For example, when the selection of the user is recognized, the scenario which has been already included in the object 730 may disappear or pay a predetermined point. Therefore, since the image illustrated in FIG. 5 is combined with the object 730, when the selection of the user is recognized, the object 730 performs an action which spurts soap bubbles and pay a predetermined reward to the user. The rewards paid to the user may be cashable or points which can be exchanged with a product or a product exchange coupon. This has been described for examples and the rewards which are payable to the user are not limited. As another example, when the selection of the user is recognized, the object 730 may provide a prize (for example, a product exchange coupon) with a predetermined probability.

There are various methods which allow the object to interact with the user in the virtual reality contents generated according to the disclosed embodiment.

For example, the background may be changed in accordance with the interaction between the object and the user. The background may be changed in accordance with a predetermined rule or arbitrarily.

The object may include various information as well as the predetermined shape or the input images. For example, the virtual reality contents may display puzzles, quizzes, problems, English vocabulary using the objects and may be set to generate learning effects according to a method or an order of selecting an object by the user.

For example, when the problem is displayed in the background of the virtual reality contents and objects including different answers are displayed, the user selects an object corresponding to the correct answer to receive a predetermined reward or go to a next problem.

Further, contents such as cartoons or movies are displayed in the background of the virtual reality contents, a predetermined amount thereof is reproduced or displayed and then stopped. In this case, the user may be requested to perform a predetermined gamification mission through interaction with the objects and contents may be additionally provided when the user accomplishes the mission.

In step S130, the computer generates virtual reality contents including the background determined in step S110 and one or more objects determined in step S120.

The generated virtual reality contents may be shared through the server 200. For example, the server 200 may provide a platform which shares or sells the generated virtual reality contents through a network and the users generate and upload the virtual reality contents.

The uploaded virtual reality contents may be shared by free of charge or may be sold at a predetermined cost.

A user who uploads the virtual reality contents may obtain a feedback for the uploaded virtual reality contents.

The feedback that the user may obtain may include a result of interaction of the other users with the objects in the virtual reality contents, an evaluation for the virtual reality contents, or a reward according to the usage of the virtual reality contents.

The reward according to the usage of the virtual reality contents may be a part of an amount paid by a user who uses the virtual reality contents or may be calculated in accordance with the number of times of using the virtual reality contents by other users or a usage time to be provided from a vendor of a platform operated by the server 200. Further, the reward may include an advertisement revenue generated by the advertisement included in the virtual reality contents.

The user may intentionally insert a specific advertisement into the virtual reality contents or when the user selects whether to include the advertisement in the virtual reality contents, the server 200 may automatically insert the advertisement into the virtual reality contents in accordance with the selection of the user.

The shared virtual reality contents may be basically provided in the form of a game which may be fun through the interaction between the object and the user. According to the exemplary embodiment, the virtual reality contents may additionally perform various functions.

For example, like SNS which shares photographs, the virtual reality contents include photographs taken by a user who generates the virtual reality contents and the included photographs may be displayed in the background of the virtual reality contents or combined with the object.

For example, the user may generate a sort of a travel journal using the virtual reality contents. The user may set the photographs to appear together with the object in accordance with the visiting order and other users may sequentially select the objects. The selected object is displayed in the background of the virtual reality contents to complete virtual reality contents which allow other users to experience the travel through the virtual reality in accordance with the traveling order of the user who generates the virtual reality contents.

As another example, the virtual reality contents may perform an alarm function. For example, the virtual reality contents are set to ring an alarm at a specific time in accordance with the setting of the user and the user needs to solve a mission through a predetermined interaction with the object in the virtual reality contents to turn off the alarm.

Further, the virtual reality contents are utilized for a video call so that different users interact with objects while watching the other party's image through the background of the virtual reality contents.

As described above, the method for generating virtual reality contents according to the disclosed embodiment may generate various virtual reality contents depending on a background, an object, and a type of scenario which is interactable with the object. Virtual reality contents according to various exemplary embodiments which are not limited to the above-described example and are shared using a platform through the server 200.

Steps of the method or algorithm described in connection with the exemplary embodiment of the present disclosure may be directly implemented by hardware or implemented by a software module executed by the hardware or a combination thereof. The software module may reside on RAM (Random Access Memory), ROM (Read Only Memory), EPROM (Erasable Programmable ROM), EEPROM (Electrically Erasable Programmable ROM), a flash memory, a hard disk, a removable disk, a CD-ROM, or an arbitrary computer readable recording medium known in the art.

The exemplary embodiments of the present invention have been described with reference to the accompanying drawings, but those skilled in the art will understand that the present disclosure may be implemented in another specific form without changing the technical spirit or an essential feature thereof. Therefore, it should be understood that the above-described exemplary embodiments are illustrative in all aspects and do not limit the present disclosure.

What is claimed is:

1. A method of generating virtual reality (VR) contents by a computer, the method comprising:
determining a background of the virtual reality contents;
determining one or more objects to be included in the virtual reality contents, the one or more objects including a predetermined scenario which is interactable with the user in response to an input of a user who uses the virtual reality contents; and
generating the virtual reality contents including the determined background and one or more objects.

2. The method according to claim 1, wherein the determining of a background includes:
determining a close-range view of the virtual reality contents; and
determining a distant view of the virtual reality contents.

3. The method according to claim 1, wherein the determining of a background includes:
providing a list including one or more backgrounds;
receiving a selection input for at least one background included in the list; and
determining the selected background as a background of the virtual reality contents.

4. The method according to claim 1, wherein the determining of a background includes:
obtaining an image to be used as a background of the virtual reality contents; and
determining the obtained image as a background of the virtual reality contents.

5. The method according to claim 4, wherein the determining of a background further includes:
converting the obtained image into a 360-degree image when the obtained image is not a 360-degree image.

6. The method according to claim 5, wherein the converting of the obtained image includes:
obtaining a distortion pattern image corresponding to distortion of an image generated during a process of converting the obtained image into a 360-degree image;
distorting the obtained image based on the obtained distortion pattern image; and
converting the distorted image into a 360-degree image.

7. The method according to claim 1, wherein the determining of one or more objects includes:
providing a list including one or more objects;
receiving a selection input for at least one object included in the list; and
adding the selected object to the virtual reality contents.

8. The method according to claim 1, wherein the determining of one or more objects includes:
determining a shape of the one or more objects; and
determining a scenario of the one or more objects; and
the scenario includes at least one of an appearance condition, an appearance position, an appearance time of one or more objects, a user's input recognition method for one or more object, a reaction to the input of the user, and a result in accordance with the interaction between the user and one or more objects.

9. The method according to claim 1, further comprising:
sharing the generated virtual reality contents; and
obtaining a feedback for the shared virtual reality contents.

10. A computer program which is combined with a computer which is a hardware to be stored in a computer readable recording medium to perform the method according to claim 1.
